(19) United States
(12) Patent Application Publication
(10) Pub. No.: US 2009/0271212 A1
(43) Pub. Date: Oct. 29, 2009

(54) METHOD, SYSTEM, AND STORAGE DEVICE FOR USER MATCHING AND COMMUNICATION FACILITATION

(75) Inventors: Rajen Savjani, El Lago, TX (US); Samir Giri, Houston, TX (US)

Correspondence Address: HULSEY IP INTELLECTUAL PROPERTY LAWYERS, P.C., 919 Congress Avenue, Suite 919, AUSTIN, TX, 78701, US

(73) Assignee: CITY 17, LLC, Houston, TX (US)

(21) Appl. No.: 12/431,809

(22) Filed: Apr. 29, 2009

Related U.S. Application Data
(60) Provisional application No. 61/048,857, filed on Apr. 29, 2008.

(51) Int. Cl. G06Q 99/00

(52) U.S. Cl. 705/1

(57) ABSTRACT

A method, system, and storage device for user matching and communication facilitation capable of receiving responses to at least one profile from at least one user. The profile having at least two sections. The first section having answers about the user and the second section having answers about what the user is looking for in another user. The answers are stored in a database system and automatically compared to other user's answers. Points are awarded for matches between two users answers to the same profile and if the points exceed a preset threshold, the two users are given the opportunity to communicate. Weighting can be employed on a question by question basis in each profile to provide a more accurate match. Furthermore, users can create custom profiles.

### RELATED APPLICATIONS

This application claims the benefit of priority to U.S. Provisional Patent Application No. 61/048,857 entitled “A METHOD, SYSTEM, AND STORAGE DEVICE FOR USER MATCHING AND COMMUNICATION FACILITATION” filed Apr. 29, 2008.

### FIELD OF THE INVENTION

The disclosed subject matter relates primarily to systems and methods for matching networking services.

### BACKGROUND OF THE INVENTION

Generally, a matching network service focuses on the building and verifying of online relationships between people who share interests and activities. More specifically, matching network services can be broken into three major divisions: social, professional, and dating. Social networking sites, such as Friendster™ or FaceBook™, are generally focused on connecting people seeking friendship or other social interaction. Professional networking sites, such as LinkedIn™, are generally focused on connecting, and building networks of professional persons. Finally, dating networking services are intended to connect people with mutually agreeable characteristics desiring to start a more personal intimate relationship.

Matching network services can also be divided into how a connection is formed—either through ‘known’ connections or ‘new’ connections. Traditional social networking services, focus on connecting people through ‘known’ connections—the people they already know. These services provide a way to map out all your relationships to the people you know and then see their connections to other people. This allows you to browse a social network of people and see how they are connected to you. You can then establish new relationships or connections with people by virtue of the people you know in common. In other services, such as traditional dating sites, you establish ‘new’ connections. With these services you do not establish relationships through a social network, but rather through published characteristics of the person. On these services, people enter characteristics about themselves and the service assists in finding other people that match their characteristics. This is usually done by the services allowing the person to manually search through its database of people, looking for persons that match their characteristics.

As an example of the typical steps of a matching network service, dating networking services will be focused on. Generally, the “normal” process of using a dating networking service encompasses four major steps. The first step is filling out a user profile. The user profile will usually contain: a username, picture, location, physical characteristics (height, body type, weight, age, eye color, etc.), religion, personality characteristics (outgoing, shy, outdoors type, etc.), and/or a freeform writing area for additional information. Next, the user would perform searches of other users' profiles in an attempt to locate other users with appealing profiles. Third, the user would review the profiles that matched the user's search parameters and determine whether the other user was a good match. Finally, a user would initiate communication with another user. The communication is traditionally accomplished through an internal e-mail messaging system in order to keep each user's names and contact information confidential.

The current dating networking services model creates several problems. First, new users were immediately forced to enter extensive amounts of data upon registration to populate the profile. This required the user to invest a substantial amount of time prior to evaluating the systems “look and feel” or evaluating the systems feature set. Further, few, if any, social networking services had more than one profile. By having one (or at most a handful) of profiles available to a user, the user was forced to use profiles that were either homogenized and generic or too specific. For example, on a professional social networking service, the profile would only have questions regarding professional activities and little or nothing about dating characteristics. Also, the user is forced to use the questions created by the system operator which may have little or no relation to the questions the user would ask if given the opportunity.

An additional problem of current social networking services are each user perform a search of other users profiles in order to locate a match. This can result in cumbersome and time-consuming searches in order to locate a potential match and require constant refinement to narrow down the list of potential matches. Further, there are very few sites that allow for a particular user who is approached by another user to determine whether the user approaching them would be a good match or to filter or limit which users may initiate communication with them. This same issue creates another problem of certain users being bombarded and overwhelmed by users trying to “meet” them. This is an especially large problem for females. On traditional social networking services, females could receive hundreds of responses per day with no idea of which, if any, of the responses are from users who would be a good match.

In addition to, or instead of, searching, the social networking service could implement a “degree of separation” methodology. This type of methodology allows users within some defined degree of separation access to each other. This is similar to a family tree. If user 1 is friends with user 2 and user 2 is friends with user 3, then by virtue of user 1 and user 3's being friends of user 2, they are allowed to communicate with each other. Therefore, although user 1 and user 3 may not be friends, they are allowed to communicate because they are within a certain degree of separation of each other. This style of social networking service does nothing to evaluate whether user 1 and user 3 have anything in common besides user 2. As the degree of separation grows higher, the chance two users have anything in common grows even smaller.

An additional problem of current social networking services is the passive nature of the communication once a match is established. Current social networking services provide internal email correspondence between members. The internal nature of the email service is intended to maintain confidentiality between users, theoretically until the users are comfortable enough with each other to reveal their identities. Through this passive communication, it could takes days, weeks, or months to find out any information from the other user. Generally, one user will initiate communication after performing a search of the profiles. The user will send an email to the other users internal email box. If the other user ever logs back into the service, weeks could have passed since the initial contact.

Yet another problem with current social networking services is stale profiles. When conducting a search of profiles, users are generally searching all the profiles on a particular service. However, this may include outdated profiles for people who have not used the website for months (or years). The profile may now have the wrong information, the user may have already found the job or social partner the user was seeking, the user may not even be monitoring the internal email system.

Another common environment people use to meet one another are online chat rooms. Generally, a chat provider will have many (hundreds or thousands) of available chat rooms. Each chat room will be loosely classified based on a topic. Theoretically, people of similar interests would go into a chat room and have a conversation with the other participants. However, as discussed previously, there could be several thousand different chat rooms to choose from and even though each has a topic, the topics could be incredibly broad or incredibly precise which makes it difficult to determine which chat room might offer the best potential match. In addition, each chat room only has a single topic thereby making it difficult or impossible to meet a person with common interests beyond the topic of the particular chat room. Further, the sheer number of chat rooms adds to the difficulties. Overall, even though chat rooms overcome the problem of passive communication, they really offer no assistance in meeting a person with common interests.

All of these problems lead to a long drawn out cumbersome process that has little chance of providing a good match and is generally discouraging to the participants.

### BRIEF SUMMARY OF THE INVENTION

There is a need for a method, system, and/or storage device that allows users to prepare one or more profiles which are matched to other users based on analytic comparisons and provide the users the ability to review the pending matches of users currently online to independently evaluate the quality of the match prior to initiating a live communication with one or more of the matched users.

One aspect of the disclosed subject matter is allowing users to use multiple profiles.

Another aspect of the disclosed subject matter is allowing users to create profiles that can be used by any user of the service, with questions that a particular user feels are important.

Another aspect of the disclosed subject matter is to create profiles that have two distinct sections. The “My Answers” section, that contains the user's answers to the questions in a profile, and the “What I am Looking For” section that contains the answers for the same questions that the user wants to see in another user's profile to be considered a match.

An additional aspect of the disclosed subject matter is to allow real-time communication between users that have matched profiles and have specifically authorized communication from a particular user(s).

Another aspect of the disclosed subject matter is to perform two way match analytics.

An additional aspect of the disclosed subject matter is to perform matching analytics with multiple profiles simultaneously.

An additional aspect of the disclosed subject matter is to automatically perform matching analytics and provide the users an indication of the quality of the match.

Yet another aspect of the disclosed subject matter is to facilitate immediate communication between matched users that have authorized communication.

These and other aspects of the disclosed subject matter, as well as additional novel features, will be apparent from the description provided herein. The intent of this summary is not to be a comprehensive description of the claimed subject matter, but rather to provide a short overview of some of the subject matter's functionality. Other systems, methods, features and advantages here provided will become apparent to one with skill in the art upon examination of the following FIGUREs and detailed description. It is intended that all such additional systems, methods, features and advantages that are included within this description, be within the scope of the claims to be filed with any regular utility patent application claiming priority based on this provisional filing.

### BRIEF DESCRIPTIONS OF THE DRAWINGS

The features, nature, and advantages of the disclosed subject matter will become more apparent from the detailed description set forth below when taken in conjunction with the accompanying drawings, wherein:

FIG. 1 illustrates a computer system and related peripherals that may operate with the match networking system of the present embodiment.

FIG. 2 depicts a system overview of the match networking system of the present embodiment.

FIGS. 3a, 3b, 3c, and 3d depict the major functions of the matching engine, user portal, and user agent, respectively, of the match networking system of the present embodiment.

FIG. 4 depicts a flowchart of the general user authentication process of the match networking system of the present embodiment.

FIG. 5 depicts a flow chart of the account creation dialog of the match networking system of the present embodiment.

FIG. 6 depicts a flowchart of the profile management system of the match networking system of the present embodiment.

FIGS. 7a, 7b, and 7c depict graphical representations of examples of the matching analytics of the match networking system of the present embodiment.

FIG. 8 depicts a chart of an example of the match score calculation of the match networking system of the present embodiment.

FIG. 9 depicts a graphical representation of cross profile matching of the match networking system of another embodiment.

FIG. 10 depicts a flow chart of the post match process for the match networking system of the present embodiment

FIG. 11 depicts a graphical representation of the dashboard for the match networking system of the present embodiment

FIG. 12 depicts a graphical representation of the dashboard for the match networking system of the preferred embodiment.

### DETAILED DESCRIPTION OF ILLUSTRATIVE EMBODIMENTS

Although described with reference to personal computers, one skilled in the art could apply the principles discussed herein to any computing or mobile device capable of sending and receiving communications, by way of example and not of limitation, personal digital assistants, mobile digital assistants, cell phones, consoles, etc. Further, one skilled in the art could apply the principles discussed herein to communication mediums beyond the Internet, by way of example and not of limitation, local area networks, wide area networks, cellular networks, other wireless technologies, etc.

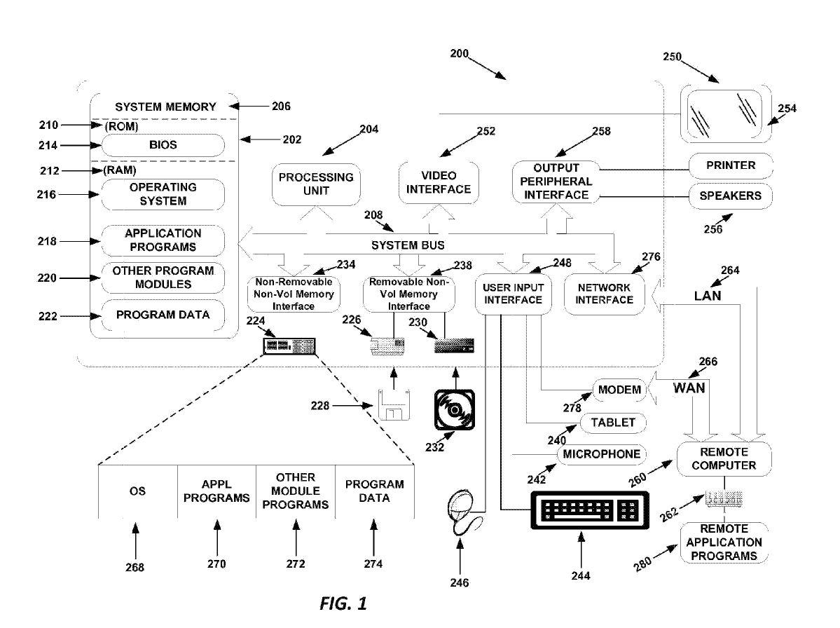

With reference to FIG. 1, an exemplary system within a computing environment for implementing the invention includes a general purpose computing device in the form of a computing system 200, commercially available from Intel, IBM, AMD, Motorola, Cyrix and others. Components of the computing system 202 may include, but are not limited to, a processing unit 204, a system memory 206, and a system bus 236 that couples various system components including the system memory to the processing unit 204. The system bus 236 may be any of several types of bus structures including a memory bus or memory controller, a peripheral bus, and a local bus using any of a variety of bus architectures.

Computing system 200 typically includes a variety of computer readable media. Computer readable media can be any available media that can be accessed by the computing system 200 and includes both volatile and nonvolatile media, and removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data.

Computer memory includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing system 200.

The system memory 206 includes computer storage media in the form of volatile and/or nonvolatile memory such as read only memory (ROM) 210 and random access memory (RAM) 212. A basic input/output system 214 (BIOS), containing the basic routines that help to transfer information between elements within computing system 200, such as during start-up, is typically stored in ROM 210. RAM 212 typically contains data and/or program modules that are immediately accessible to and/or presently being operated on by processing unit 204. By way of example, and not limitation, an operating system 216, application programs 220, other program modules 220 and program data 222 are shown.

Computing system 200 may also include other removable/non-removable, volatile/nonvolatile computer storage media. By way of example only, a hard disk drive 224 that reads from or writes to non-removable, nonvolatile magnetic media, a magnetic disk drive 226 that reads from or writes to a removable, nonvolatile magnetic disk 228, and an optical disk drive 230 that reads from or writes to a removable, nonvolatile optical disk 232 such as a CD ROM or other optical media could be employed to store the invention of the present embodiment. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 224 is typically connected to the system bus 236 through a non-removable memory interface such as interface 234, and magnetic disk drive 226 and optical disk drive 230 are typically connected to the system bus 236 by a removable memory interface, such as interface 238.

The drives and their associated computer storage media, discussed above, provide storage of computer readable instructions, data structures, program modules and other data for the computing system 200. For example, hard disk drive 224 is illustrated as storing operating system 268, application programs 270, other program modules 272 and program data 274. Note that these components can either be the same as or different from operating system 216, application programs 220, other program modules 220, and program data 222. Operating system 268, application programs 270, other program modules 272, and program data 274 are given different numbers hereto illustrates that, at a minimum, they are different copies.

A user may enter commands and information into the computing system 200 through input devices such as a tablet, or electronic digitizer, 240, a microphone 242, a keyboard 244, and pointing device 246, commonly referred to as a mouse, trackball, or touch pad. These and other input devices are often connected to the processing unit 204 through a user input interface 248 that is coupled to the system bus 208, but may be connected by other interface and bus structures, such as a parallel port, game port or a universal serial bus (USB).

A monitor 250 or other type of display device is also connected to the system bus 208 via an interface, such as a video interface 252. The monitor 250 may also be integrated with a touch-screen panel or the like. Note that the monitor and/or touch screen panel can be physically coupled to a housing in which the computing system 200 is incorporated, such as in a tablet-type personal computer. In addition, computers such as the computing system 200 may also include other peripheral output devices such as speakers 254 and printer 256, which may be connected through an output peripheral interface 258 or the like.

Computing system 200 may operate in a networked environment using logical connections to one or more remote computers, such as a remote computing system 260. The remote computing system 260 may be a personal computer, a server, a router, a network PC, a peer device or other common network node, and typically includes many or all of the elements described above relative to the computing system 200, although only a memory storage device 262 has been illustrated. The logical connections depicted include a local area network (LAN) 264 connecting through network interface 276 and a wide area network (WAN) 266 connecting via modem 278, but may also include other networks. Such networking environments are commonplace in offices, enterprise-wide computer networks, intranets and the Internet.

For example, in the present embodiment, the computer system 200 may comprise the source machine from which data is being migrated, and the remote computing system 260 may comprise the destination machine. Note however that source and destination machines need not be connected by a network or any other means, but instead, data may be migrated via any media capable of being written by the source platform and read by the destination platform or platforms.

The central processor operating pursuant to operating system software such as IBM OS/2®, Linux®, UNIX®, Microsoft Windows®, Apple Mac OSX® and other commercially available operating systems provides functionality for the services provided by the present invention. The operating system or systems may reside at a central location or distributed locations (i.e., mirrored or standalone).

Software programs or modules instruct the operating systems to perform tasks such as, but not limited to, facilitating client requests, system maintenance, security, data storage, data backup, data mining, document/report generation and algorithms. The provided functionality may be embodied directly in hardware, in a software module executed by a processor or in any combination of the two.

Furthermore, software operations may be executed, in part or wholly, by one or more servers or a client's system, via hardware, software module or any combination of the two. A software module (program or executable) may reside in RAM memory, flash memory, ROM memory, EPROM memory, EEPROM memory, registers, hard disk, a removable disk, a CD-ROM, DVD, optical disk or any other form of storage medium known in the art. An exemplary storage medium is coupled to the processor such that the processor can read information from, and write information to, the storage medium. In the alternative, the storage medium may be integral to the processor. The processor and the storage medium may also reside in an application specific integrated circuit (ASIC). The bus may be an optical or conventional bus operating pursuant to various protocols that are well known in the art.

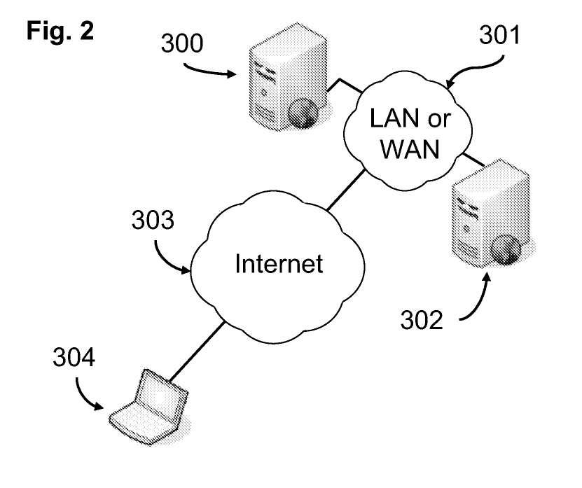

FIG. 2 depicts a system overview of the match networking system of the present embodiment. The overall system can be broken into three major components: matching engine 300, user portal 302, and user agent 304. The matching engine 300 and the user portal 302 are connected together through a local or wide area network 301 to the Internet 303.

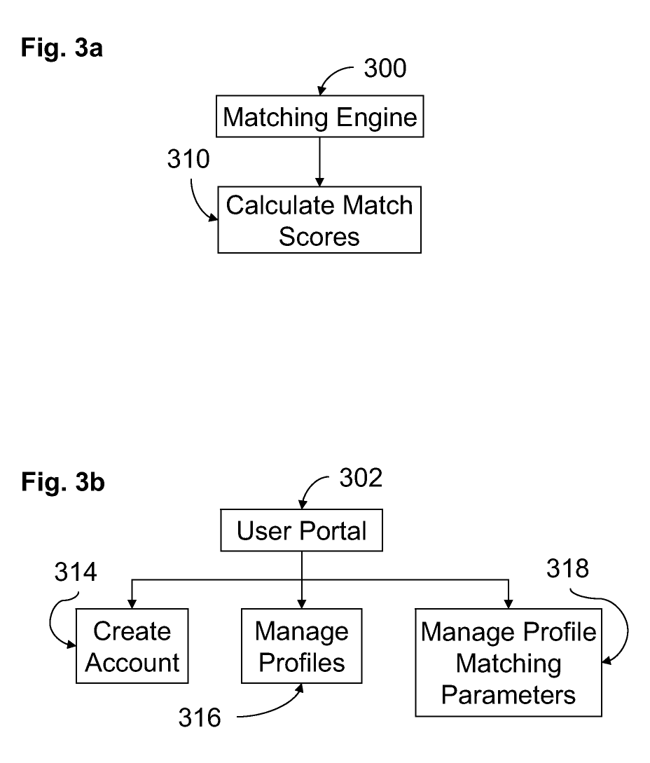

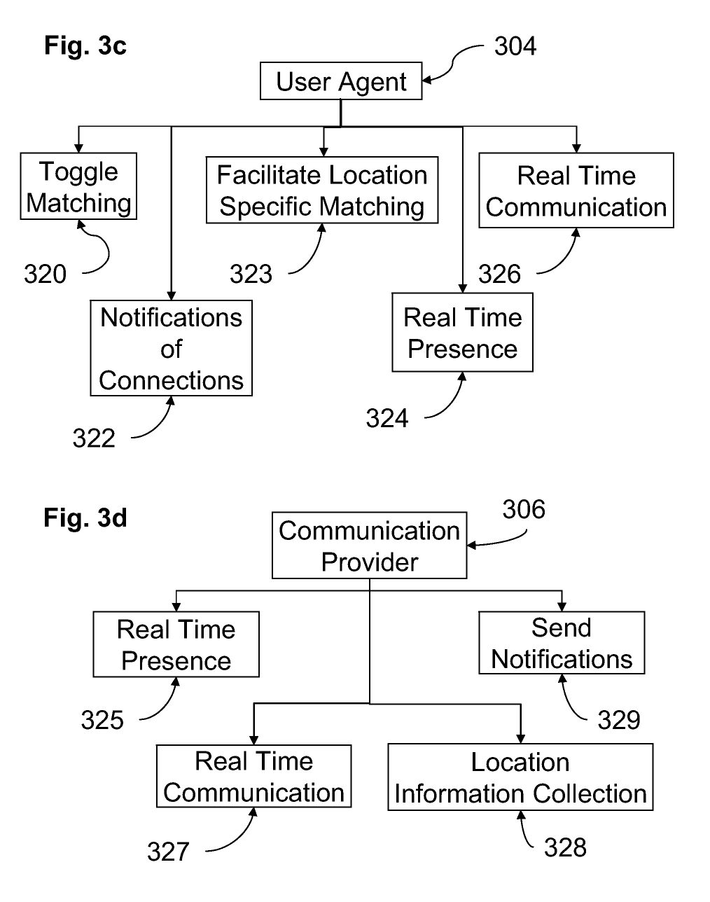

FIGS. 3a, 3b, 3c, and 3d depict the major functions of the matching engine 300, user portal 302, user agent 304, and communication provider 306, respectively, of the match networking system of the present embodiment. Referring to FIG. 3a, the matching engine 300 contains logic to calculate match scores 310 between users. In the preferred embodiment, the match scores are only calculated and presented for users currently online. Referring to FIG. 3b, the user portal 302 contains logic to enable the user to create an account 314, manage profiles 316, and manage profile matching parameters 318. Referring to FIG. 3c, the user agent 304 provides a client-side application that allows the user to enable or disable matching 320, provides notification of pending and permanent connections 322, facilitate matching based on location by providing location information 323, facilitates real-time matching by providing real-time presence 324, and enables real-time communication between users 326. In the preferred embodiment, the user portal 302 and the user agent 304 are incorporated in the same web application interface. Finally, referring to FIG. 3d, the communication provider 306 is a server side application that sends notifications to the user agents 304 notifying of pending and/or permanent connections 329, collects location information to facilitate location based matching 328, facilities real-time matching by collecting real-time presence 325, and enables real-time communication between users 327.

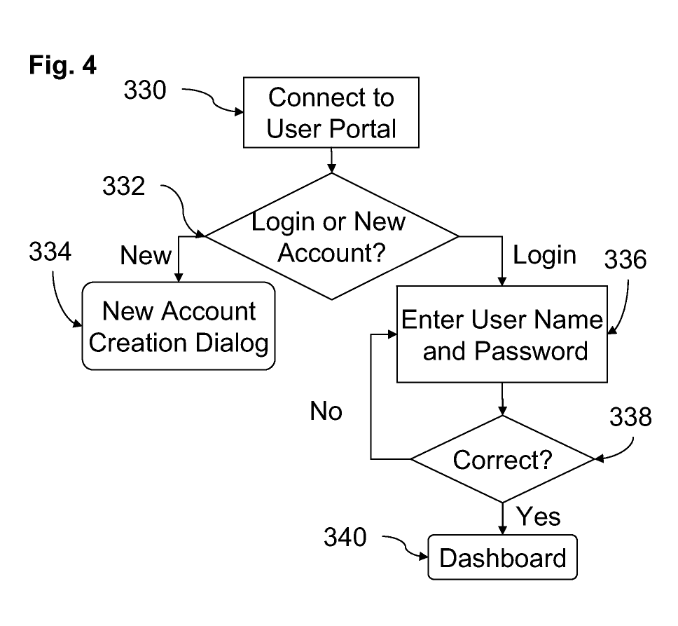

FIG. 4 depicts a flowchart of the general user authentication process of the match networking system of the present embodiment. The user would first connect to the user portal 330. The user would then indicate whether the user desired to login to an existing account or create a new account 332. If the user chose to create a new account, the user would be directed to the new account creation screen 334. If the user chose to login to an existing account, the user would be prompted to enter the user's user name and password 336. If the user name and password are correct 338, the user would be directed to the dashboard 340.

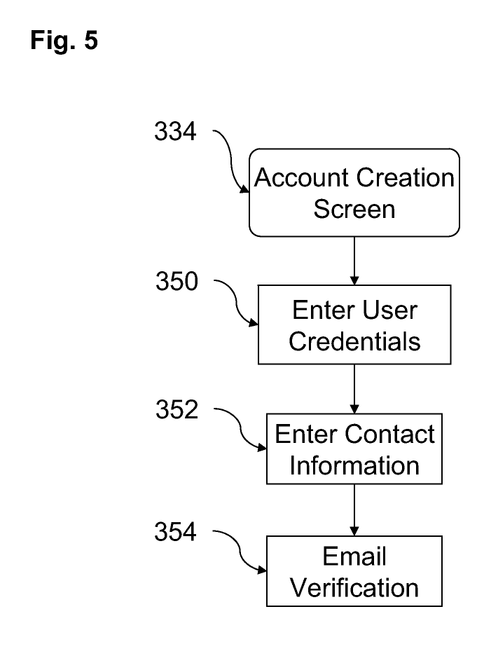

FIG. 5 depicts a flow chart of the account creation screen 334 of the match networking system of the present embodiment. The user would first be prompted to enter their email address as their user name and a corresponding password 350. Next, the user would enter general contact information 352 which could include: first name, last name, address, city, state, nation, time-zone, and email address. In the preferred embodiment, the user would not be required to fill-out and add a profile during the initial account creation screen. Finally, email verification is performed 354. Email verification consists of the system generating an email and sending the email to the email address the user entered. The user must then login into the user's email account, retrieve the system generated email, and perform some action (click a hyperlink, enter a string of characters contained in the system generated email into a webpage, etc.). This allows the system to verify the email address the user entered is a real email address and that the user has access to the email address.

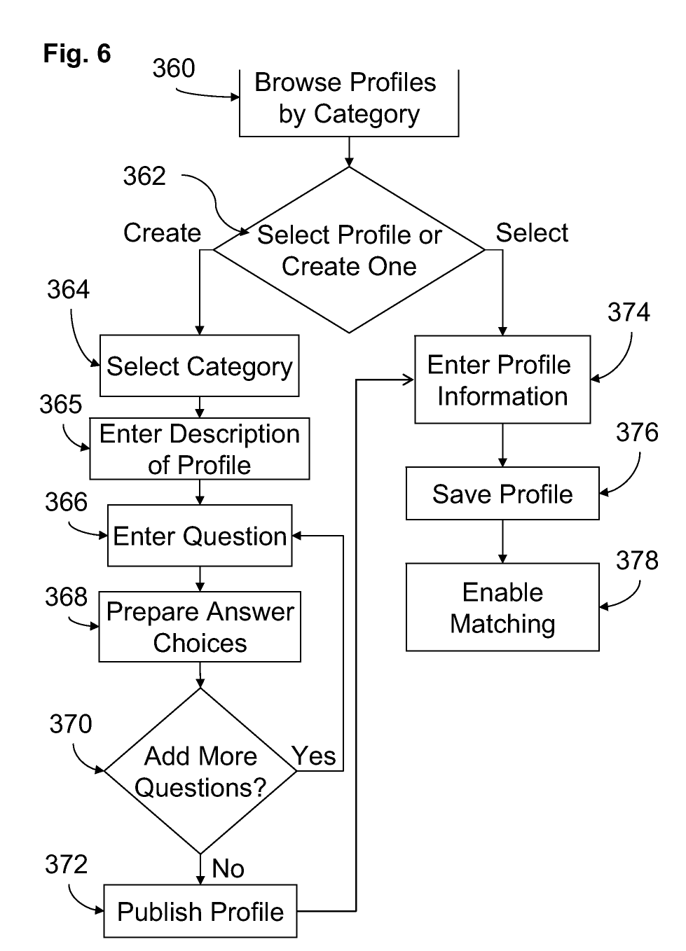

Once logged into the system, the user may add and fill-out one or more profiles. Profiles are basically questionnaires that help to identify particular character traits and/or desires of the user as well as character traits and/or desires of the potential match. As briefly discussed earlier, in other social networking services, there existed only one profile that was typically designed by the system operators and focused on the particular theme of the social networking service (business, dating, friendship, etc.). However, in the present embodiment, users will not only have access to several different profiles created by the system operators, but will also be able to create profiles for use by all members of the site. Additionally, users will be permitted to have multiple active profiles. FIG. 6 depicts a flowchart of the profile management system of the match networking system of the present embodiment. A user will be provided with a list of existing profiles broken into categories (sports, college, personal, business, dating, hobbies, etc.) 360. Once a user selected a particular category, a list of all of the available profiles under the selected category would be displayed. In the preferred embodiment a brief description of the profile and the number of users using the profile would be displayed for each listing. The user may then choose an existing profile or, if the user does not find a profile the user likes, the user can create a profile 362.

A user can create a profile that contains questions the particular user finds important. By creating a profile, users gain the ability to craft the questionnaire and ask questions that are pertinent to a particular group of users. For example, one user may find astrological signs of critical importance while another user may want several questions about religion. First, the user would select a broad theme that best fits the profile 364 for category placement. Then the user would enter basic information about the profile including a title, description, picture, etc 365. Then the user would enter questions 366. In the preferred embodiment, the user would enter a question and then determine what type of answer the user would like. For example, a user could ask a “yes/no” question, a question with a finite number of responses, or an open-ended question. The user would then enter the possible answer choices, or in the case of an open-ended question, chose a “text box” where the user could answer 368. Next the user is given the opportunity to add additional questions 370. Once the user has entered all the questions/answers the user wants, the user is given the option to publish the profile 372 or save it as draft. Once the profile is published, the profile will appear in the listing of profiles by category 360 where any user may choose it and enter the requested information. After publishing the profile, or if the user selected an existing profile, the user would be prompted to enter the requested information into the profile 374. The profile information 374 contains two parts: “My Answers” and “What I am Looking For”. The “My Answers” portion of the profile is for the user to provide his/her answers to the questions in the profile. The “What I am Looking For” portion of the profile is for the user to provide how other users should answer the same question in order to be considered a match. Additionally, for each “What I am Looking For” question, the user would select an importance level. The importance level indicates how important a match on that particular question is to the user. For example, if a user was only looking for another person who was a cyclist, the user would rate the question with a higher importance; however, if the other person's astrological sign was not important, the user would rate astrological sign with a lower importance. In the preferred embodiment, there would be at least three different levels of importance: must have, relevant, and not relevant; however, there could be more or fewer importance levels. If the user was happy with the answers submitted, the user would then choose to save the profile 376. Finally, the user would be given the opportunity to enable the profile for matching 378. Enabling a profile for matching means the user desires the system to begin using the profile for match analytics.

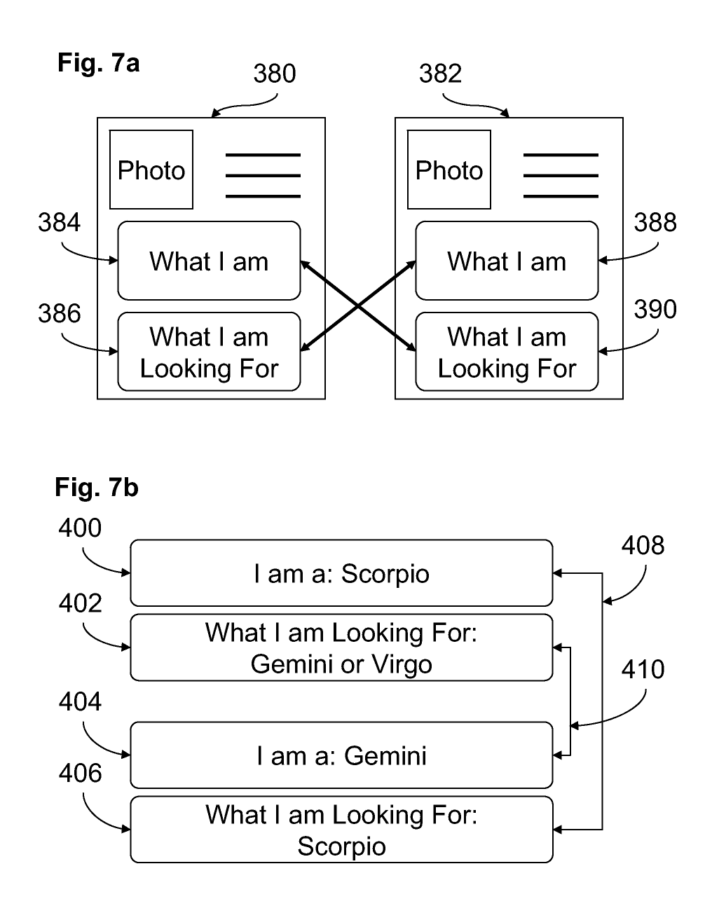

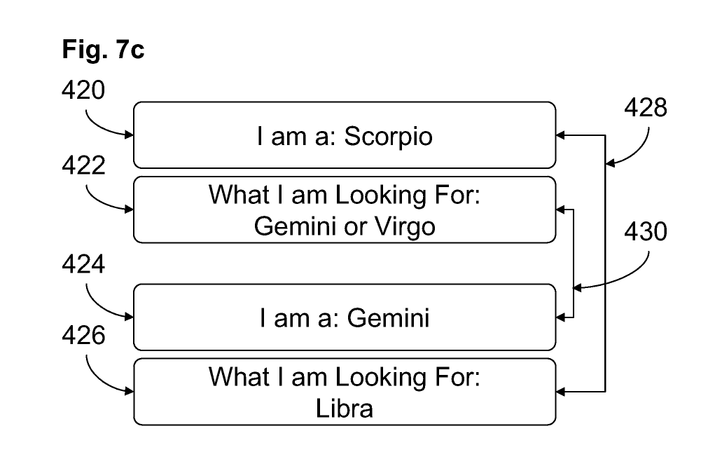

FIGS. 7a, 7b, and 7c depict graphical representations of examples of the matching analytics of the match networking system of the present embodiment. The matching analytics performs a two-way analysis between profiles. A “match score” is calculated that represents how closely two users meet each other's criteria. In order to calculate the match score, the matching analytics compares one user's “My Answers” against another user's “What I am Looking For.” For example, referring to FIG. 7a, the first user's profile 380 and the second user's profile 382 are compared. Therefore, the first user's “My Answers” portion 384 is compared with the second user's “What I am Looking For” portion 390. Conversely, the second user's “My Answers” portion 388 is compared with the first user's “What I am Looking For” portion 386. The “match score” is a measure of how both satisfy each other's criteria. This two-way matching allows for a greater quality of match over more traditional matching that only compares a searching user's “What I am Looking For” criteria with another user's “My Answers” information (performing a “one-way match”).

The “match score” calculation is based on analytics performed on a question by question basis. In the current embodiment, a component of the “match score” is based on points awarded for each matching “My Answers” “What I am Looking for” pair. For example, referring to FIG. 7b, two user's answers to a particular question are displayed. In this example, the first user reported he/she was a Scorpio 400 and the second user reported he/she was looking for a Scorpio 406; so points would be awarded based on this matching pair. Additionally, the second user's “My Answers” is compared with the first user's “What I am Looking For” 410. Here, the first user reported he/she was looking for a Gemini and Virgo 402 and the second user reported he/she was a Gemini 404; therefore, in this example there was a matching pair, and points were awarded.

Referring to FIG. 7c, two user's answers to a particular question are displayed. In this example, comparing the first user's “What I am Looking For” 422 and the second user's “My Answers” 424 results in points being awarded for a matching pair 430; however, comparing the second user's “What I am Looking For” 426 and the first user's “My Answers” 420 does not result in a matching pair 428. Therefore, in this example, points were awarded for only one pair.

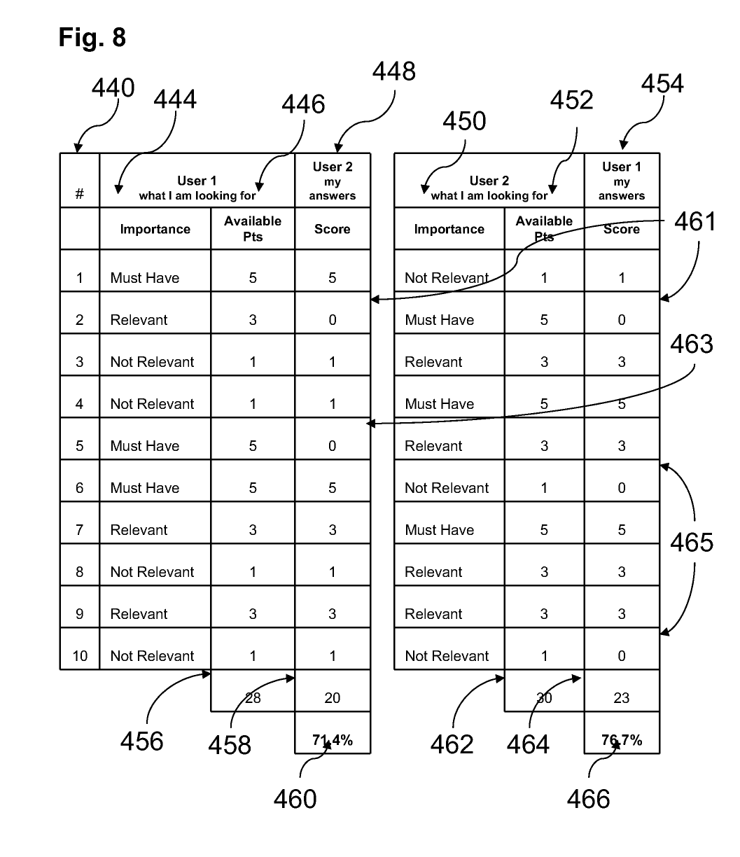

FIG. 8 depicts a chart of an example of the match score calculation of the match networking system of the present embodiment. Once the question by question comparison is complete, each result is awarded points based on the user's importance level for each question. FIG. 8 shows, for each question 440, and what importance level user 1 444 and user 2 450 assigned to each question. Further, the figure shows a simple weighting method that assigns a specific weight to each importance level. In this example, “must have” corresponds to five points, “relevant” corresponds to three points, and “not relevant” corresponds to one point. Therefore, if user 1 designated a particular question “must have” and the question was a match (e.g. user 2's “My Answers” matched user 1's “What I am Looking For”), the score for that question for user 2's “My Answers” would be five; however, if there was no match, then the score for that question for user 2 would be zero. The available points column for user 1 446 and for user 2 452 show the points that would be assigned to a particular question for that respective user, if the question's “My Answers” “What I am Looking For” pair resulted in a match. The total of the available points for user 1 456 and user 2 462 correlate to the total number of points if every question was a match. Therefore, in this example, based on user 1's importance levels, the total possible points available, if every question was a match, would be 28 456. Similarly, in this example, based on user 2's importance levels, the total possible points available, if every question was a match, would be 30 462. The score column for user 2 448 and for user 1 454 shows the points actually assigned for a particular question, respective to the user. In this example, for question #2, neither user 1 nor user 2 matched the other users “What I am Looking For” 461. For question #5, user 2 did not match user 1's “What I am Looking For”; therefore, user 2 received no points 463. For questions #6 and #10, user 1 did not match user 2's “What I am Looking For”; therefore, user 1 received no points 465. In this example, the total of the points actually assigned for user 2 is 20 458 and for user 1 is 23 464. With this information, a “user score” can be calculated for both users. Because each user can assign a different importance level to each question, the user score can be different for the two compared users. In this example, user 2 had a user score of 71.4% 460. This represents that, after weighting, user 2 matched 71.4% of user 1's “What I am Looking For” questions. Similarly, in this example, user 1 had a user score of 76.7% 466. Again, this represents that, after weighting, user 1 matched 76.7% of user 2's “What I am Looking For” questions. A “match score” (not shown) is then calculated by taking the square root of the product of the two user scores 460 and 466. In the above example, this would result in a score of 74.0%. Clearly, the weights assigned to the different levels of importance, the number and definition of the different levels of importance, and/or the calculation method can be modified to fit the particular need.

If the match score equaled or exceeded a preset threshold match score, the matching profiles would be shown to the respective users. In the preferred embodiment, matching analytics are performed only between profiles of users that are currently online. In another embodiment, matching analytics are performed continuously across all users and all profiles even if those users are not currently online; however, any match scores would not be delivered to the respective users until both users were online.

In the preferred embodiment, each user could set a custom threshold match score for each profile. By setting a custom threshold match score, the user would only be presented with matches where the match score equaled or exceeded the threshold for each user. Though the weighting in the above charts was completed by assigning a point value to each importance level, other forms of weighting and/or statistical analysis could be employed and still remain within the scope of this disclosure.

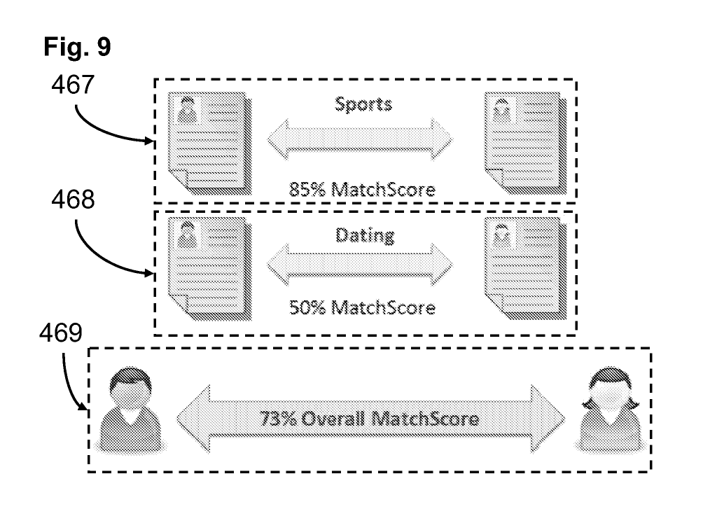

FIG. 9 depicts a graphical representation of cross profile matching of the match networking system of another embodiment. In addition to calculating a match score on a per profile basis, in another embodiment, matching can occur across multiple profiles. For example, if two users had both a sports profile 467 and a dating profile 468, the match analytics would not only perform a match score for each profile, but also an overall match score across all the profiles the two users had in common 469.

In yet another embodiment, users in close geographic proximity (e.g. within several city blocks) to each other would receive notification that a match was near by. Further, the system could assist the users in locating a meeting place.

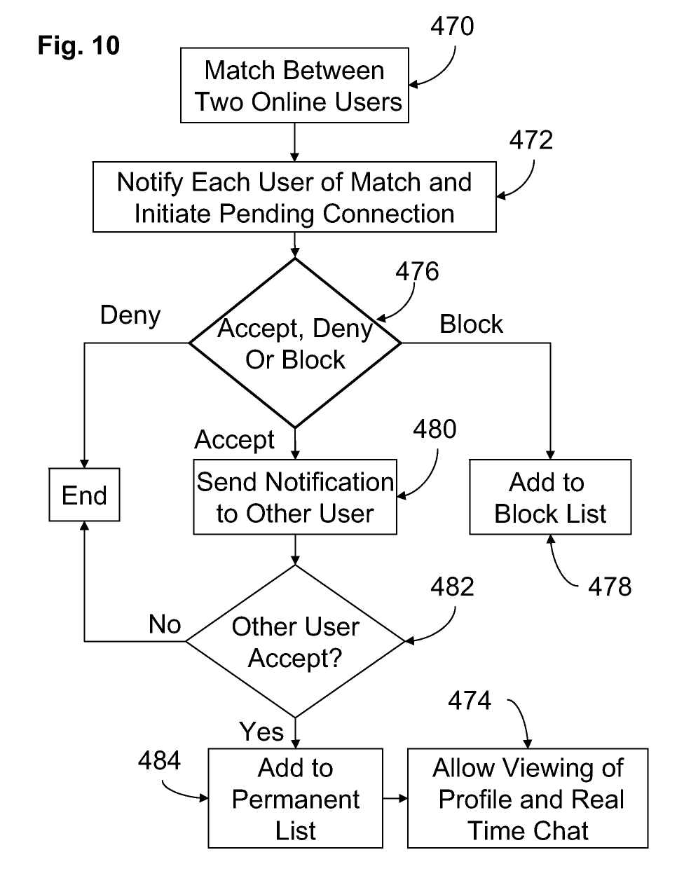

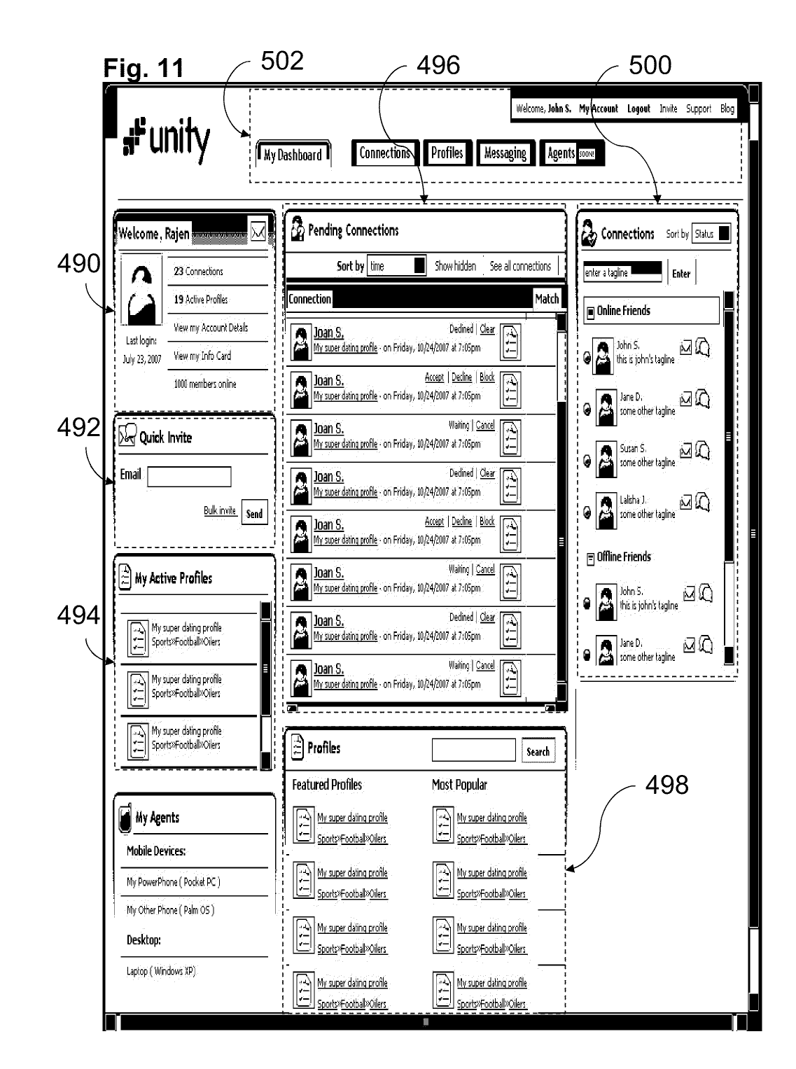

FIG. 10 depicts a flow chart of the post match process for the matching networking system of the present embodiment. When a match occurs that equals or exceeds the threshold match score of each user 470, the respective users are notified of the match, the system generates a pending connection, and both users are notified of the pending connection 472. The pending connection remains active until either a user takes action on the pending connection or a user is no longer online. Both users are given the option to accept, decline, or block the pending connection 476. If either user chooses to decline the pending connection, the pending connection is terminated. In the preferred embodiment, the next time either user logs on a new pending connection could be generated provided the profile has been modified and the match criteria are met again. Each user is also given the option of blocking a user. If a user is blocked, the blocked user is added to the other user's blocked list 478. The blocked list will prevent the blocked user from generating a connection with the user on any profile in the future. In addition, a blocked user cannot communicate directly with the user through any of the messaging available on the site. In the preferred embodiment, the decline option only stops a pending connection between two users on a particular profile. There still exists the possibility of a later pending connection between the two users if a match is triggered pursuant to a different profile or if the profile that elicited the decline is later modified. If either of the users chooses to accept a pending connection, a notification of the request is sent to the other user 480. If the other user chooses to decline the pending connection, the pending connection is terminated and the next time both users log on, a pending connection between the users will not be regenerated for this profile, unless either member has modified the profile after the initial decline. Furthermore, this denial is only for a match for a particular profile, the two users could still match pursuant to one or more other profiles. If the other user chooses to accept the pending connection, each user is added to the other user's permanent connection list 484. The matched users may then initiate communication via real-time chat 474 or via the system's built in messaging system. After two users have a permanent connection, the two users may continue to communicate via real-time chat anytime they are both online; it is not necessary for the two users to go through the match and post-match processes. It is important to note, communication is only allowed between users who have established a permanent connection.

In an additional embodiment, a user can add a permanent connection to a “favorites” (e.g. friends) list for quick access to a user.

In another embodiment, the users could view any of the other user's profiles in addition to the matched profiles. In yet another embodiment, each user could upload files and attach them to a profile, for the other user to view.

Additionally, in the preferred embodiment, introduction information may be provided to each user upon creating a permanent connection. This introduction information would normally include introductory text entered by the particular user, but could also include files such as pictures, documents, audio files, etc. In an alternative embodiment, the introduction information is provided when at least one of the users has accepted the pending connection. In yet another alternative embodiment, the introduction information can be provided before either user has accepted the pending connection.

FIG. 11 depicts a graphical representation of the dashboard for the match networking system of an alternative embodiment. The dashboard is the main screen displayed to the user upon logging in. The dashboard displays most of the major functions of the match networking system. Specifically, the dashboard shows: user's information 490, quick invite 492, user's active profiles 494, user's pending connections 496, profiles 498, permanent connections 500, and navigational buttons 502. The user's information 490 contains general information about the user's account such as name, number of connections, number of active profiles, number of users currently online, etc. The quick invite 492 allows users to invite other people who are not currently a user of the system to become a user of the system. The user's active profiles 494 lists the user's profiles that are currently active. The pending connections 496 lists users that are currently online and that match with one or more of the user's profiles. The pending connections 496 also lists which profile was matched and the match score for the match. There are also buttons for the user to accept, decline, or block a pending connection. The profiles 498 shows one or more featured profiles, one or more of the most popular profiles, and a search function that allows the user to search all of the available profiles. The permanent connections 500 lists all of the users permanent connections broken down into those currently online and those offline. There are also buttons to initiate communication such as email to both online and offline users and/or live chat to online users. Finally, there are navigational buttons 502 which provide easy access to other portions of the service such as: connections, profiles, messaging, account, logout, support, etc.

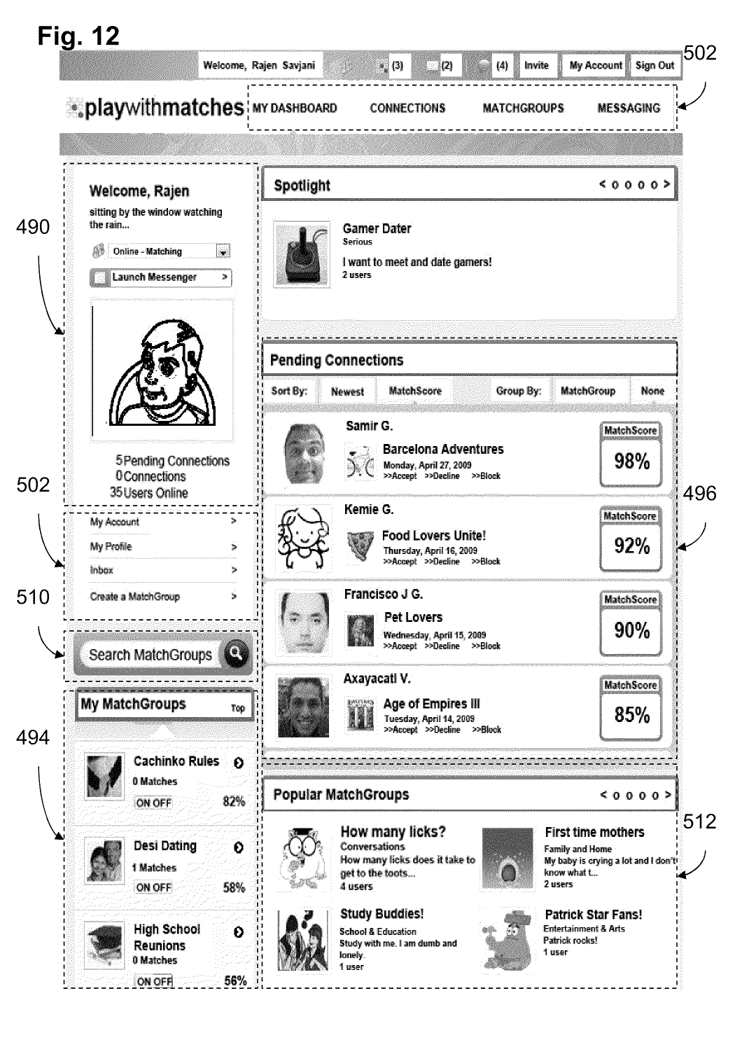

FIG. 12 depicts a graphical representation of the dashboard for the match networking system of the preferred embodiment. The current user's information 490 is shown. Additionally, the user's active profiles (or “MatchGroups”) 494 and pending connections 496 are displayed. Navigation links 502 to other pertinent information are provided, such as: account information, profile information, messaging, profile (or MatchGroup) creation, permanent connections, etc. Finally, a way to search for profiles (or MatchGroups) 510 and a list of some popular profiles (or MatchGroups) 512 is provided.

Those with skill in the arts will recognize that the disclosed embodiments have relevance to a wide variety of areas in addition to those specific examples described below.

All references, including publications, patent applications, and patents, cited herein are hereby incorporated by reference to the same extent as if each reference were individually and specifically indicated to be incorporated by reference and were set forth in its entirety herein.

What is claimed is:

1. A method for user matching and communication facilitation, said method comprising the steps of:
receiving responses to at least one of a plurality of profiles, said profiles having at least a first section and a second section, said first section regarding a user and said second section regarding what said user desires of another user;
storing a first user's responses in a database system, said database system residing on a computer;
storing a second user's responses in said database system;
performing matching analytics between said first user's responses for a particular profile and said second user's responses to the same said particular profile, said matching analytics comprising:
identifying matches for said particular profile between said first user's responses to said second section and said second user's responses to said first section;
identifying matches for said particular profile between said second user's responses to said second section and said first user's responses to said first section; and
awarding points according to said matches;
creating a pending connection between said first user and said second user if said points exceeds at least one predetermined threshold;
facilitating communication between said first user and said second user.

2. The method of claim 1, said communication performed in real-time.

3. The method of claim 1, said step of facilitating communication is performed only after said first user and said second user accept said pending connection.

4. The method of claim 1, said step of creating said pending connection is completed only when said first user and said second user are online.

5. The method of claim 1, with the additional step of permitting at least one of said users to create at least one profile.

6. The method of claim 1, said step of awarding points additionally including the step of weighting the points awarded according to at least two importance levels.

7. The method of claim 6, said importance levels assigned to each question in said profile by said first user and said second user.

8. The method of claim 7, with the additional steps of:
calculating said first user's user score;
calculating said second user's user score; and
calculating a match score from said first user's user score and said second user's user score.

9. The method of claim 1, with the additional step of delivering at least one of introduction text and introduction files.

10. The method of claim 1, with the additional step of identifying said first user's geographic location and said second user's geographic location and creating said pending connection when said geographic locations are within a predetermined distance.

11. A tangible computer readable medium for user matching and communication facilitation, said medium containing a program, said program comprising the steps of:
receiving responses to at least one of a plurality of profiles, said profiles having at least a first section and a second section, said first section regarding a user and said second section regarding what said user desires of another user;
storing a first user's responses in a database system, said database system residing on a computer;
storing a second user's responses in said database system;
performing matching analytics between said first user's responses for a particular profile and said second user's responses to the same said particular profile, said matching analytics comprising:
identifying matches for said particular profile between said first user's responses to said second section and said second user's responses to said first section;
identifying matches for said particular profile between said second user's responses to said second section and said first user's responses to said first section; and
awarding points according to said matches;
creating a pending connection between said first user and said second user if said points exceeds at least one predetermined threshold;
facilitating communication between said first user and said second user.

12. The method of claim 11, with the additional step of permitting at least one of said users to create at least one profile.

13. The method of claim 11, said step of awarding points additionally including the step of weighting the points awarded according to at least two importance levels.

14. The method of claim 13, said importance levels assigned to each question in said profile by said first user and said second user.

15. The method of claim 11, said step of creating said pending connection is completed only when said first user and said second user are online.

16. The method of claim 11, with the additional step of delivering at least one of introduction text and introduction files.

17. The method of claim 11, with the additional step of identifying said first user's geographic location and said second user's geographic location and creating said pending connection when said geographic locations are within a predetermined distance.

18. A system for user matching and communication facilitation, said system comprising:
at least one communication medium;
at least two users;
a database system, said database system residing on said computer and storing a first user's responses and a second user's responses to at least one of a plurality of profiles, said responses received via said communication medium;
said profiles having at least a first section regarding said user and a second section regarding what said user desires of another user;
a matching system, said matching system:
identifying matches between said first user's first section and said second user's second section;
identifying matches between said second user's first section and said first user's second section; and
awarding points according to said matches;
a notification system, said notification system notifying said first user and said second user of a pending connection if said points exceeds at least one predetermined threshold; and
said communications medium facilitating communication between said first user and said second user.

19. The system of claim 18, said database system additionally storing at least one said profile created by at least one of said users.

20. The system of claim 18, additionally comprising a geographic location identification system, said geographic location identification system identifying said first user's location and said second user's location and creating said pending connection when said locations are within a predetermined distance.
